(19) United States
(12) Patent Application Publication
(10) Pub. No.: US 2018/0335224 A1
(43) Pub. Date: Nov. 22, 2018

(54) SYSTEM AND METHOD FOR OPERATING A PACKAGED TERMINAL AIR CONDITIONER UNIT BASED ON ROOM OCCUPANCY

(71) Applicant: Haier US Appliance Solutions, Inc., Wilmington, DE (US)

(72) Inventor: Christopher Bryan Rissler, La Grange, KY (US)

(21) Appl. No.: 15/598,368

(22) Filed: May 18, 2017

(51) Int. Cl. F24F 11/00; F24F 1/02; G05B 19/12

(52) U.S. Cl. CPC F24F 11/0034; F24F 1/027; G05B 19/124; G06K 7/10297; F24F 2011/0035; F24F 2011/0047; G05B 2219/2614; F24F 2011/0002

(57) ABSTRACT

A packaged terminal air conditioner unit (PTAC) and methods for operating the same are provided. The PTAC includes an auxiliary fan positioned adjacent a vent aperture defined in a bulkhead of the PTAC. A control system includes an occupancy identification source including data indicative of a room occupancy status, such as the number of room occupants. An occupancy reader is configured for reading the occupancy identification source to determine the room occupancy status and a controller selectively operates the auxiliary fan based at least in part on the room occupancy status determined by the occupancy reader.

### FIELD OF THE INVENTION

The present disclosure relates generally to air conditioner units, and more particularly to packaged terminal air conditioner units and related methods of operation.

### BACKGROUND OF THE INVENTION

Air conditioner or conditioning units are conventionally utilized to adjust the temperature indoors—i.e. within structures such as dwellings and office buildings. Such units commonly include a closed refrigeration loop to heat or cool the indoor air. Typically, the indoor air is recirculated while being heated or cooled. A variety of sizes and configurations are available for such air conditioner units. For example, some units may have one portion installed within the indoors that is connected, by e.g., tubing carrying the refrigerant, to another portion located outdoors. These types of units are typically used for conditioning the air in larger spaces.

Another type of unit, sometimes referred to as a packaged terminal air conditioner unit (PTAC), may be used for somewhat smaller indoor spaces that are to be air conditioned. These units may include both an indoor portion and an outdoor portion separated by a bulkhead and may be installed in windows or positioned within an opening of an exterior wall of a building. PTACs often need to draw air from the outdoor portion into the indoor portion. For example, if a bathroom fan is turned on or air is otherwise ejected from the indoor space, fresh air may be required to supplement or make-up for the lost air.

Accordingly, certain PTACs allow for the introduction of make-up air into the indoor space, e.g., through a vent aperture defined in the bulkhead that separates the indoor and outdoor side of the unit. The vent aperture is usually equipped with an auxiliary fan and/or make-up air module to urge a flow of make-up air from the outdoor side of the PTAC into the conditioned room. Notably, however, the amount of make-up air needed varies depending the number of room occupants. For example, government regulations or building codes may specify the amount of make-up air required for each room occupant. In addition, guest comfort may be reduced if an insufficient amount of make-up air is provided and excessive noise may be generated by the auxiliary fan if it runs faster than needed. As a result, certain facility operators or maintenance technicians will manually adjust the operating speed of the auxiliary fan depending on the number of guests that check into the room.

Accordingly, improved air conditioner units and associated control systems for selectively operating the auxiliary fan would be useful. More specifically, a control system for a packaged terminal air conditioner unit that adjusts operation of the auxiliary fan based on a room occupancy status would be particularly beneficial.

### BRIEF DESCRIPTION OF THE INVENTION

The present subject matter provides a packaged terminal air conditioner unit (PTAC) and methods for operating the same. The PTAC includes an auxiliary fan positioned adjacent a vent aperture defined in a bulkhead of the PTAC. A control system includes an occupancy identification source including data indicative of a room occupancy status, such as the number of room occupants. An occupancy reader is configured for reading the occupancy identification source to determine the room occupancy status and a controller selectively operates the auxiliary fan based at least in part on the room occupancy status determined by the occupancy reader. Additional aspects and advantages of the invention will be set forth in part in the following description, may be obvious from the description, or may be learned through practice of the invention.

In accordance with one embodiment, a control system for controlling an auxiliary fan of a packaged terminal air conditioner unit is provided. The auxiliary fan is positioned adjacent a vent aperture defined in a bulkhead of the packaged terminal conditioner unit. The control system includes an occupancy identification source including data indicative of a room occupancy status and an occupancy reader configured for reading the occupancy identification source to determine the room occupancy status. A controller is operably coupled with the occupancy reader and is configured for selectively operating the auxiliary fan based at least in part on the room occupancy status determined by the occupancy reader.

In accordance with another embodiment, a packaged terminal air conditioner unit is provided. The packaged terminal air conditioner unit includes a bulkhead defining an indoor portion and an outdoor portion, a vent aperture defined in the bulkhead, and an auxiliary fan positioned proximate the vent aperture and being configured for urging a flow of make-up air from the outdoor portion through the vent aperture to the indoor portion. A controller is configured for obtaining a room occupancy status from an occupancy identification source and selectively operating the auxiliary fan based at least in part on the room occupancy status to urge the flow of make-up air through the vent aperture.

In accordance with still another embodiment, a method for controlling an auxiliary fan of a packaged terminal air conditioner unit is provided. The auxiliary fan is positioned adjacent a vent aperture defined in a bulkhead of the packaged terminal conditioner unit. The method includes obtaining a room occupancy status from an occupancy identification source and selectively operating the auxiliary fan to urge a flow of make-up air through the vent aperture based at least in part on the room occupancy status.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an air conditioner unit, with part of an indoor portion exploded from a remainder of the air conditioner unit for illustrative purposes, in accordance with one exemplary embodiment of the present disclosure.

FIG. 2 is another perspective view of components of the indoor portion of the exemplary air conditioner unit of FIG. 1.

FIG. 3 is a schematic view of a refrigeration loop in accordance with one embodiment of the present disclosure.

FIG. 4 is a rear perspective view of an outdoor portion of the exemplary air conditioner unit of FIG. 1, illustrating a vent aperture in a bulkhead assembly in accordance with one embodiment of the present disclosure.

FIG. 5 is a front perspective view of the exemplary bulkhead assembly of FIG. 4 with a vent door illustrated in the open position in accordance with one embodiment of the present disclosure.

FIG. 6 is a rear perspective view of the exemplary air conditioner unit and bulkhead assembly of FIG. 4 including a sealed system for conditioning make-up air in accordance with one embodiment of the present disclosure.

FIG. 7 is a schematic view of a control system used to operate an auxiliary fan of the exemplary air conditioner unit of FIG. 1 according to an exemplary embodiment of the present subject matter.

FIG. 8 depicts certain components of a control system according to example embodiments of the present subject matter.

FIG. 9 illustrates a method for controlling an auxiliary fan of a packaged terminal air conditioner unit in accordance with one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

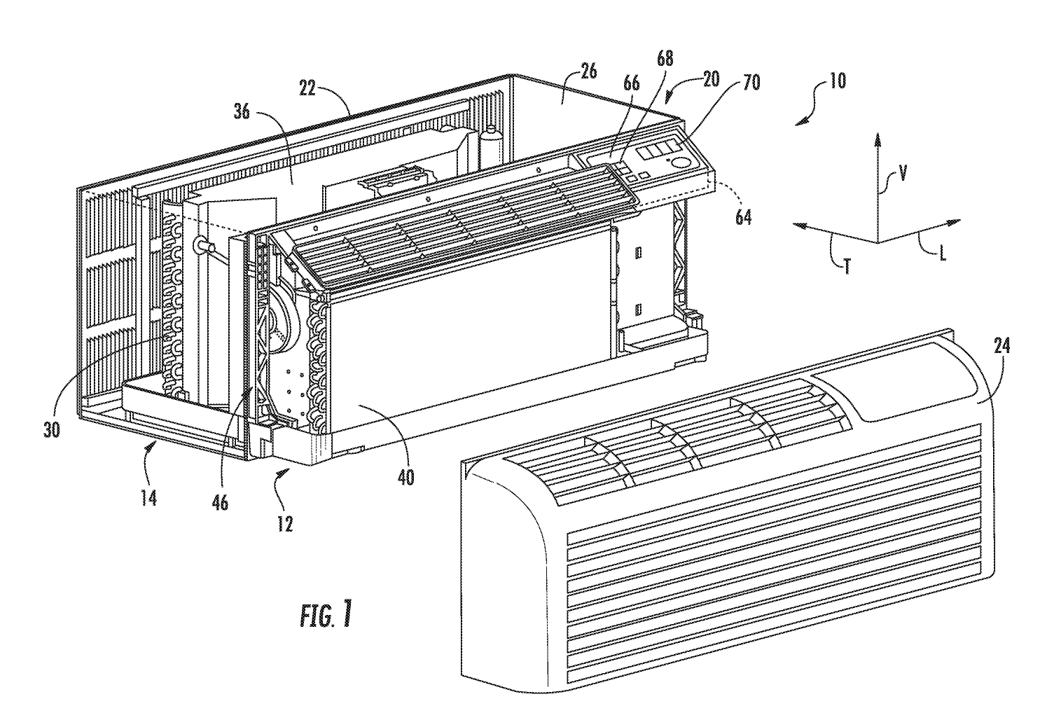

Referring now to FIG. 1, an air conditioner unit 10 is provided. The air conditioner unit 10 is a one-unit type air conditioner, also conventionally referred to as a room air conditioner or a packaged terminal air conditioner (PTAC). The unit 10 includes an indoor portion 12 and an outdoor portion 14, and generally defines a vertical direction V, a lateral direction L, and a transverse direction T. Each direction V, L, T is perpendicular to each other, such that an orthogonal coordinate system is generally defined.

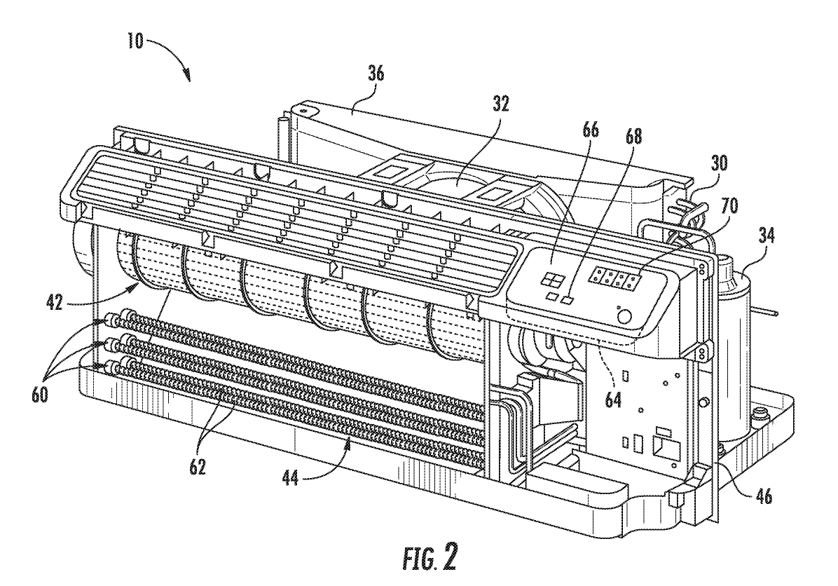

A housing 20 of the unit 10 may contain various other components of the unit 10. Housing 20 may include, for example, a rear grill 22 and a room front 24 which may be spaced apart along the transverse direction T by a wall sleeve 26. The rear grill 22 may be part of the outdoor portion 14, and the room front 24 may be part of the indoor portion 12. Components of the outdoor portion 14, such as an outdoor heat exchanger 30, an outdoor fan 32 (FIG. 2), and a compressor 34 (FIG. 2) may be housed within the wall sleeve 26. A casing 36 may additionally enclose outdoor fan 32, as shown.

Referring now also to FIG. 2, indoor portion 12 may include, for example, an indoor heat exchanger 40 (FIG. 1), a blower fan 42, and a heating unit 44. These components may, for example, be housed behind the room front 24. Additionally, a bulkhead 46 may generally support and/or house various other components or portions thereof of the indoor portion 12, such as the blower fan 42 and the heating unit 44. Bulkhead 46 may generally separate and define the indoor portion 12 and outdoor portion 14.

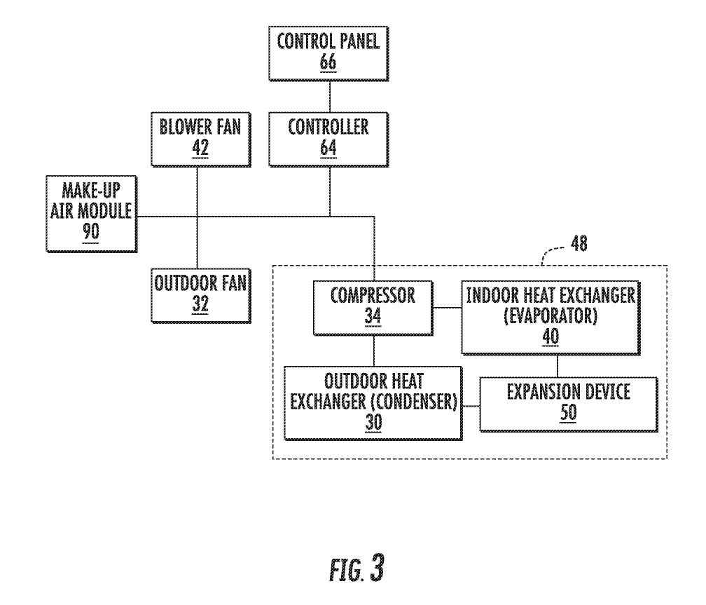

Outdoor and indoor heat exchangers 30, 40 may be components of a refrigeration loop 48, which is shown schematically in FIG. 3. Refrigeration loop 48 may, for example, further include compressor 34 and an expansion device 50. As illustrated, compressor 34 and expansion device 50 may be in fluid communication with outdoor heat exchanger 30 and indoor heat exchanger 40 to flow refrigerant therethrough as is generally understood. More particularly, refrigeration loop 48 may include various lines for flowing refrigerant between the various components of refrigeration loop 48, thus providing the fluid communication there between. Refrigerant may thus flow through such lines from indoor heat exchanger 40 to compressor 34, from compressor 34 to outdoor heat exchanger 30, from outdoor heat exchanger 30 to expansion device 50, and from expansion device 50 to indoor heat exchanger 40. The refrigerant may generally undergo phase changes associated with a refrigeration cycle as it flows to and through these various components, as is generally understood. Suitable refrigerants for use in refrigeration loop 48 may include pentafluoroethane, difluoromethane, or a mixture such as R410a, although it should be understood that the present disclosure is not limited to such example and rather that any suitable refrigerant may be utilized.

As is understood in the art, refrigeration loop 48 may be alternately be operated as a refrigeration assembly (and thus perform a refrigeration cycle) or a heat pump (and thus perform a heat pump cycle). As shown in FIG. 3, when refrigeration loop 48 is operating in a cooling mode and thus performs a refrigeration cycle, the indoor heat exchanger 40 acts as an evaporator and the outdoor heat exchanger 30 acts as a condenser. Alternatively, when the assembly is operating in a heating mode and thus performs a heat pump cycle, the indoor heat exchanger 40 acts as a condenser and the outdoor heat exchanger 30 acts as an evaporator. The outdoor and indoor heat exchangers 30, 40 may each include coils through which a refrigerant may flow for heat exchange purposes, as is generally understood.

According to an example embodiment, compressor 34 may be a variable speed compressor. In this regard, compressor 34 may be operated at various speeds depending on the current air conditioning needs of the room and the demand from refrigeration loop 48. For example, according to an exemplary embodiment, compressor 34 may be configured to operate at any speed between a minimum speed, e.g., 1500 revolutions per minute (RPM), to a maximum rated speed, e.g., 3500 RPM. Notably, use of variable speed compressor 34 enables efficient operation of refrigeration loop 48 (and thus air conditioner unit 10), minimizes unnecessary noise when compressor 34 does not need to operate at full speed, and ensures a comfortable environment within the room.

In exemplary embodiments as illustrated, expansion device 50 may be disposed in the outdoor portion 14 between the indoor heat exchanger 40 and the outdoor heat exchanger 30. According to the exemplary embodiment, expansion device 50 may be an electronic expansion valve that enables controlled expansion of refrigerant, as is known in the art. More specifically, electronic expansion device 50 may be configured to precisely control the expansion of the refrigerant to maintain, for example, a desired temperature differential of the refrigerant across the indoor heat exchanger 40. In other words, electronic expansion device 50 throttles the flow of refrigerant based on the reaction of the temperature differential across indoor heat exchanger 40 or the amount of superheat temperature differential, thereby ensuring that the refrigerant is in the gaseous state entering compressor 34. According to alternative embodiments, expansion device 50 may be a capillary tube or another suitable expansion device configured for use in a thermodynamic cycle.

According to the illustrated exemplary embodiment, outdoor fan 32 is an axial fan and indoor blower fan 42 is a centrifugal fan. However, it should be appreciated that according to alternative embodiments, outdoor fan 32 and blower fan 42 may be any suitable fan type. In addition, according to an exemplary embodiment, outdoor fan 32 and blower fan 42 are variable speed fans. For example, outdoor fan 32 and blower fan 42 may rotate at different rotational speeds, thereby generating different air flow rates. It may be desirable to operate fans 32, 42 at less than their maximum rated speed to ensure safe and proper operation of refrigeration loop 48 at less than its maximum rated speed, e.g., to reduce noise when full speed operation is not needed. In addition, according to alternative embodiments, fans 32, 42 may be operated to urge make-up air into the room.

According to the illustrated embodiment, blower fan 42 may operate as an evaporator fan in refrigeration loop 48 to encourage the flow of air through indoor heat exchanger 40. Accordingly, blower fan 42 may be positioned downstream of indoor heat exchanger 40 along the flow direction of indoor air and downstream of heating unit 44. Alternatively, blower fan 42 may be positioned upstream of indoor heat exchanger 40 along the flow direction of indoor air, and may operate to push air through indoor heat exchanger 40.

Heating unit 44 in exemplary embodiments includes one or more heater banks 60. Each heater bank 60 may be operated as desired to produce heat. In some embodiments as shown, three heater banks 60 may be utilized. Alternatively, however, any suitable number of heater banks 60 may be utilized. Each heater bank 60 may further include at least one heater coil or coil pass 62, such as in exemplary embodiments two heater coils or coil passes 62. Alternatively, other suitable heating elements may be utilized.

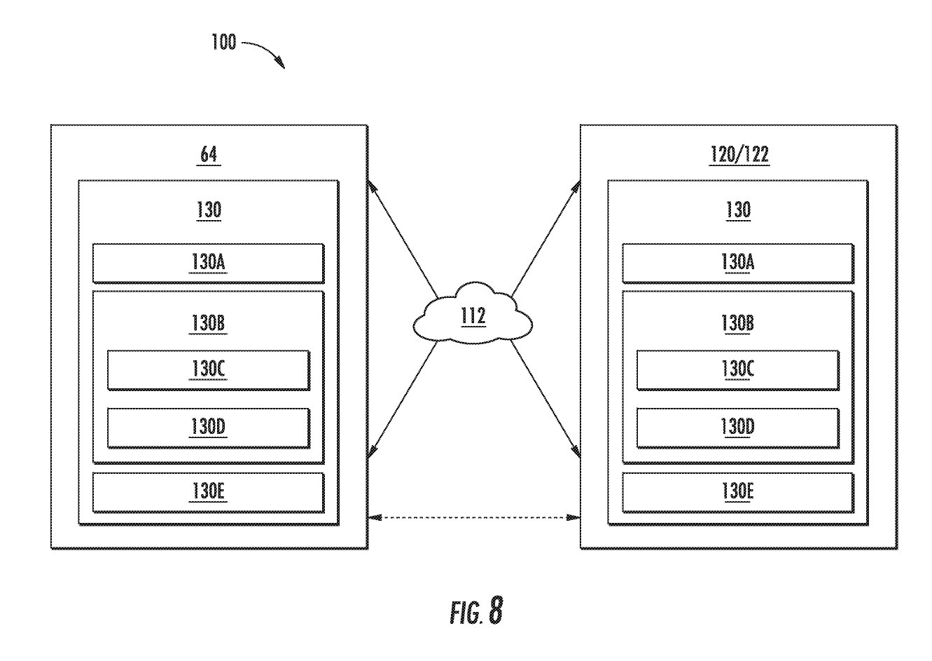

The operation of air conditioner unit 10 including compressor 34 (and thus refrigeration loop 48 generally) blower fan 42, outdoor fan 32, heating unit 44, expansion device 50, and other components of refrigeration loop 48 may be controlled by a processing device such as a controller 64. Controller 64 may be in communication (via for example a suitable wired or wireless connection) to such components of the air conditioner unit 10. As described in more detail below with respect to FIG. 8, the controller 64 may include a memory and one or more processing devices such as microprocessors, CPUs or the like, such as general or special purpose microprocessors operable to execute programming instructions or micro-control code associated with operation of unit 10. The memory may represent random access memory such as DRAM, or read only memory such as ROM or FLASH. In one embodiment, the processor executes programming instructions stored in memory. The memory may be a separate component from the processor or may be included onboard within the processor.

Unit 10 may additionally include a control panel 66 and one or more user inputs 68, which may be included in control panel 66. The user inputs 68 may be in communication with the controller 64. A user of the unit 10 may interact with the user inputs 68 to operate the unit 10, and user commands may be transmitted between the user inputs 68 and controller 64 to facilitate operation of the unit 10 based on such user commands. A display 70 may additionally be provided in the control panel 66, and may be in communication with the controller 64. Display 70 may, for example be a touchscreen or other text-readable display screen, or alternatively may simply be a light that can be activated and deactivated as required to provide an indication of, for example, an event or setting for the unit 10.

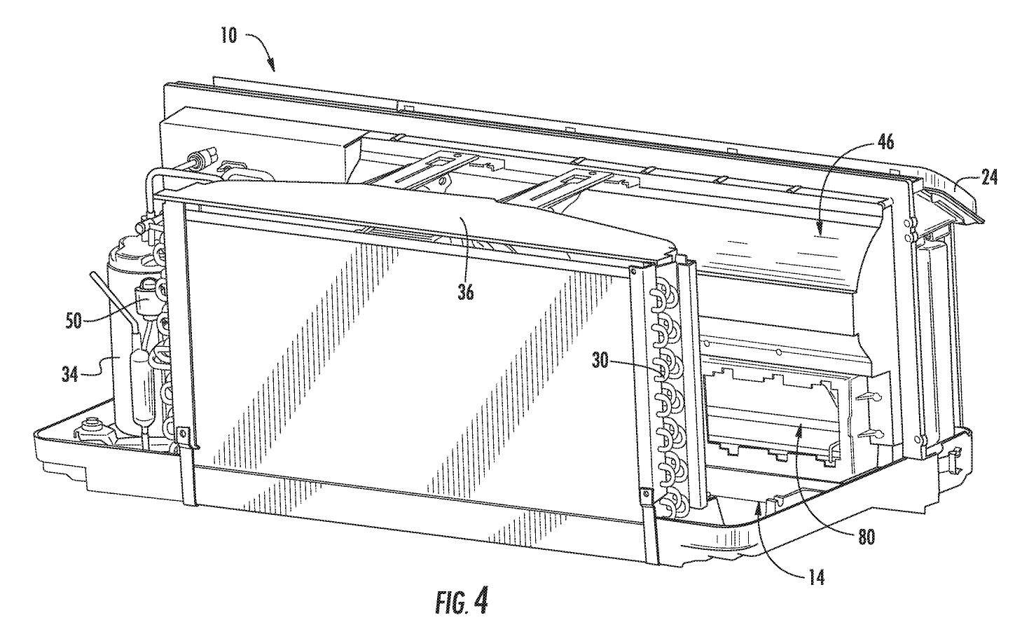

Referring briefly to FIG. 4, a vent aperture 80 may be defined in bulkhead 46 providing fluid communication between indoor portion 12 and outdoor portion 14. Vent aperture 80 may be utilized in an installed air conditioner unit 10 to allow outdoor air to flow into the room through the indoor portion 12. In this regard, in some cases it may be desirable to allow outside air (i.e., “make-up air”) to flow into the room in order, e.g., to meet government regulations, or to compensate for negative pressure created within the room. In this manner, according to an exemplary embodiment, make-up air may be provided into the room through vent aperture 80 when desired.

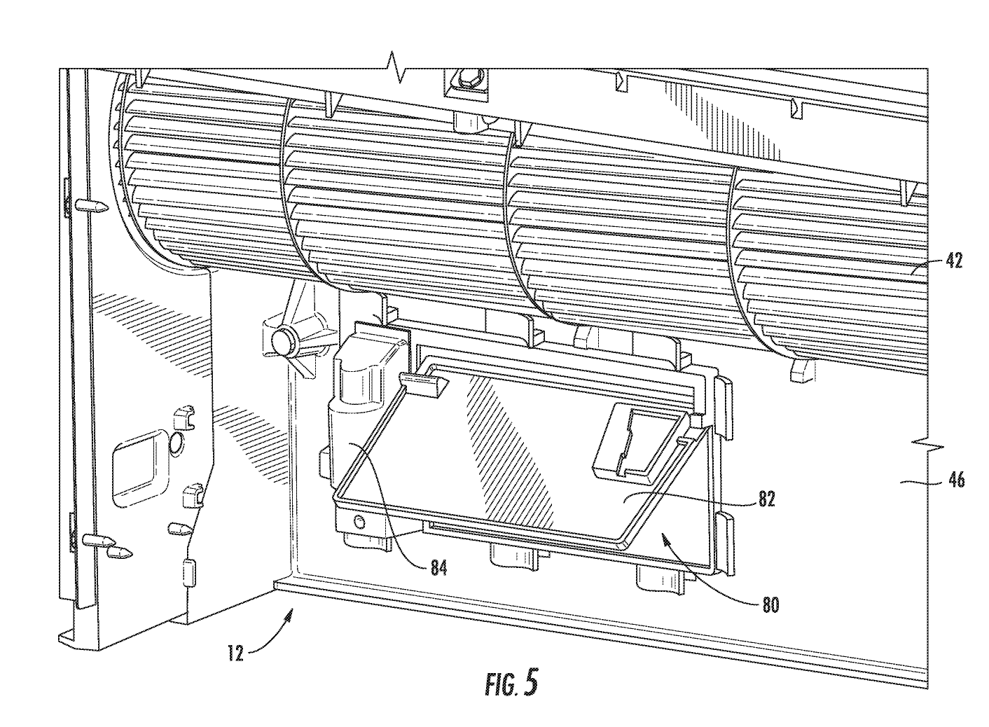

As shown in FIG. 5, a vent door 82 may be pivotally mounted to the bulkhead 46 proximate to vent aperture 80 to open and close vent aperture 80. More specifically, as illustrated, vent door 82 is pivotally mounted to the indoor facing surface of indoor portion 12. Vent door 82 may be configured to pivot between a first, closed position where vent door 82 prevents air from flowing between outdoor portion 14 and indoor portion 12, and a second, open position where vent door 82 is in an open position (as shown in FIG. 5) and allows make-up air to flow into the room. According to the illustrated embodiment vent door 82 may be pivoted between the open and closed position by an electric motor 84 controlled by controller 64, or by any other suitable method.

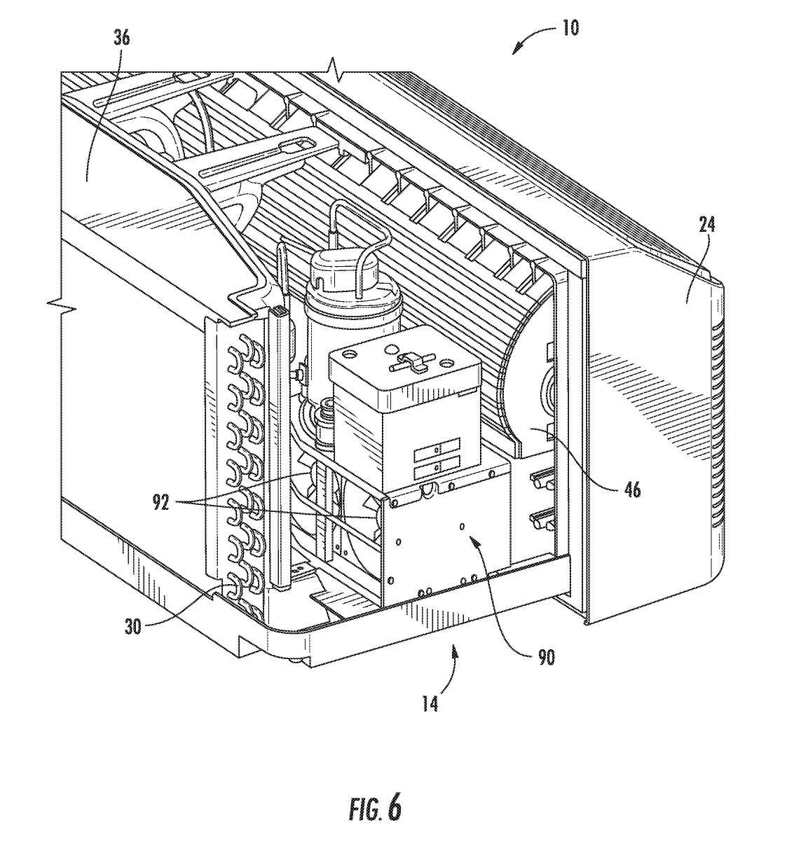

In some cases, it may be desirable to treat or condition make-up air flowing through vent aperture 80 prior to blowing it into the room. For example, outdoor air which has a relatively high humidity level may require treating before passing into the room. In addition, if the outdoor air is cool, it may be desirable to heat the air before blowing it into the room. Therefore, as illustrated in FIG. 6, unit 10 may further include an auxiliary sealed system, or make-up air module 90, for conditioning make-up air. As shown, make-up air module 90 and/or an auxiliary fan 92 are positioned within outdoor portion 14 adjacent vent aperture 80 and vent door 82 is positioned within indoor portion 12 over vent aperture 80, though other configurations are possible. According to the illustrated embodiment auxiliary sealed system 90 may be controlled by controller 64, by another dedicated controller, or by any other suitable method.

As illustrated, make-up air module 90 includes auxiliary fan 92 that is configured as part of auxiliary sealed system 90 and may be configured for urging a flow of air through auxiliary sealed system 90. Auxiliary sealed system 90 may further includes one or more compressors, heat exchangers, and any other components suitable for operating auxiliary sealed system 90 similar to refrigeration loop 48 described above to condition make-up air. For example, auxiliary system 90 can be operated in a dehumidification mode, an air conditioning mode, a heating mode, a fan only mode where only auxiliary fan 92 is operated to supply outdoor air, an idle mode, etc.

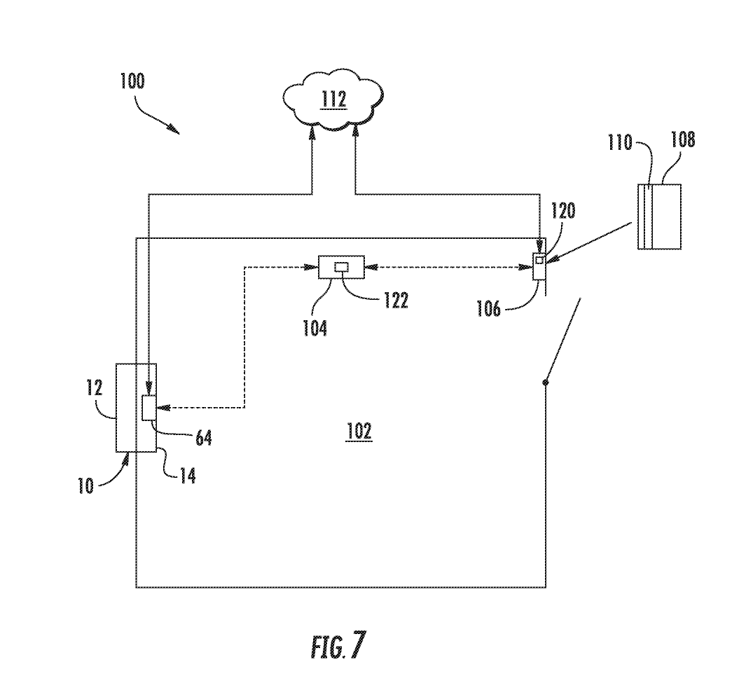

Referring now to FIG. 7, a control system 100 used to control an auxiliary fan and/or a make-up air module of a packaged terminal air conditioner unit is described according to an exemplary embodiment. Using unit 10 as an example, control system 100 is generally used to selectively operate auxiliary fan 92 to provide a flow of make-up air into a room 102 at a desired flow rate based on room occupancy, as described below. Although control system 100 is described herein as one exemplary configuration for operatively coupling auxiliary fan 92 or make-up air module 90 with a source of occupancy information, it should be appreciated that other configurations are possible while remaining within the scope of the present subject matter.

According to the illustrated embodiment, room 102 includes a door, a packaged terminal air conditioner unit, such as unit 10, and a thermostat 104. In addition, an occupancy reader is positioned within the room and is generally configured for reading an occupancy identification source, as described below. More specifically, according to the exemplary illustrated embodiment, the occupancy reader is a keycard reader 106 positioned within room 102 near the door. In addition, the occupancy identification source is a keycard 108 having a magnetic strip 110 that is configured to be read by the keycard reader 106. It should be appreciated that FIG. 7 illustrates an exemplary embodiment that is not intended to limit the scope of the present subject matter. Other components or different types of components may be included in room 102 for controlling the make-up air flow rate while remaining within the scope of the present subject matter. These various components may be in direct or indirect communication using any suitable wired or wireless connection and one or more networks 112, as described in detail below.

Using FIG. 7 as an example, operation of control system 100 will be described according to an example embodiment. Upon entering the room, the guest puts keycard 108 into a slot of keycard reader 106. According to one embodiment, keycard reader 106 and keycard 108 are used as an occupancy indicator for the room 102. Thus, for example, keycard reader 106 starts electricity to the room 102 and reads information programmed into magnetic strip 110 when keycard 108 is inserted into keycard reader 106.

Keycard 108 may be encoded with information regarding the reserved room information as well as the number of guests staying in the room 102. The information may be populated automatically based on the reservation information or entered while the guest is checking in at the front desk of the hotel. For example, a facility employee at the front desk may confirm a room occupancy status during check-in and program that information into keycard 108. As used herein, “room occupancy status” may refer the number of room occupants, the target make-up air flow rate, or any other information that may be used by the packaged terminal air conditioner unit 10 or make-up air module 90 to determine the proper make-up air flow rate.

The room occupancy status may be relayed to unit 10 and/or make-up air module 90 in any suitable manner. According to one exemplary embodiment, magnetic strip 110 may have a numeric code encoded into it. In this regard, for example, magnetic strip 110 may include a six-digit code—the first four digits may contain the room number and the fifth and sixth numbers designate the number of occupants in the room 102. Further digits may also include information related to the desired flow rate of make-up air module 90, the room temperature settings when the room is unoccupied (e.g., when keycard 108 is removed), a preferred operating schedule, a preferred auxiliary schedule the hotel or facility can fill out before renting out room 102, or any other suitable information.

The exemplary embodiment described above describes the room occupancy status and other information being relayed to make-up air module 90 using magnetic strip 110 on keycard 108. However, it should be appreciated that this information may be relayed using any other suitable method. For example, the room occupancy status may be entered by the guest using a keypad when they enter room 102, may be encoded in a barcode and read by a barcode scanner, may be communicated using a mobile phone application, may be transmitted using an RFID chip, or may be relayed in any other manner.

When the guest places keycard 108 into keycard reader 106 such that the room occupancy status is relayed to keycard reader 106, that information will then be transferred to unit 10, or directly to make-up air module 90, for use in controlling the make-up air flow rate. Keycard reader 106 may be coupled to unit 10 through any suitable wired or wireless connection, as described in more detail below. Keycard reader 106 may include a reader controller 120 and/or thermostat 104 may include a thermostat controller 122. One or more of controllers 120, 122 may be in communication with controller 64 of unit 10 through a direct or indirect, wired or wireless connection.

After the room occupancy status is received by unit 10, unit 10 communicates the room occupancy status, e.g., the number of room occupants to make-up air module 90. According to an alternative embodiment, controller 64 of unit 10 may be used to directly operate make-up air module 90. Notably, the amount of make-up air required for room 102 is directly tied to the number of people staying in room 102. By tying the occupancy directly to what is reported at the front desk, the amount of make-up air can be adjusted for each additional occupant. In this manner, make-up air module 90 provides the appropriate amount of air to meet government regulations and building codes, keeps the noise created by make-up air module 90 to a minimum, and maintains guest comfort and satisfaction at a maximum. In addition, by automatically adjusting the operation of make-up air module 90 to provide the required amount of make-up air, a facility operator will not need to change the setting in each unit 10 when each guest or guests check into their room.

For example, make up air module 90 takes the room occupancy status and adjusts the speed of auxiliary fan 92 to give the correct flow rate of make-up air in cubic feet per minute (CFM). According to one exemplary embodiment, the volumetric flow rate is about twenty CFM when there is one room occupant and the volumetric flow rate is about thirty-five CFM when there are two or more room occupants. According to other embodiments, each additional guest may increase the target flow rate by approximately fifteen CFM.

FIG. 7 describes one exemplary configuration of control system 100 for controlling the operation of auxiliary fan 92 for the purpose of explaining aspects of the present subject matter. However, it should be appreciated that although specific exemplary embodiments are described, modifications and variations may be made to the illustrated control system 100 while remaining within the scope of the present subject matter. For example, controller 64 of unit 10 is illustrated as part of control system 100 for controlling operation of auxiliary fan 92. However, according to alternative embodiments, make-up air module 90 could include a dedicated controller. In addition, keycard reader 106 may be in operative communication with unit 10 and make-up air module 90 in any other suitable manner.

FIG. 8 depicts certain components of control system 100 according to example embodiments of the present disclosure. As shown and described above, unit 10 includes controller 64, thermostat 104 includes thermostat controller 122, and keycard reader 106 includes keycard controller 120. Controllers 64, 120, and 122 can be configured to communicate directly or via one or more network(s) (e.g., network(s) 112). Controllers 64, 120, and 122 can include one or more computing device(s) 130. Although similar reference numerals will be used herein for describing the computing device(s) 130 associated with controllers 64, 120, and 122 respectively, it should be appreciated that each of controllers 64, 120, and 122 may have a dedicated computing device 130 not shared with the other. According to still another embodiment, only a single computing device 130 may be used to implement method 200 as described below, and that computing device 130 may be included as part of controllers 64, 120, and 122.

Computing device(s) 130 can include one or more processor(s) 130A and one or more memory device(s) 130B. The one or more processor(s) 130A can include any suitable processing device, such as a microprocessor, microcontroller, integrated circuit, an application specific integrated circuit (ASIC), a digital signal processor (DSP), a field-programmable gate array (FPGA), logic device, one or more central processing units (CPUs), graphics processing units (GPUs) (e.g., dedicated to efficiently rendering images), processing units performing other specialized calculations, etc. The memory device(s) 130B can include one or more non-transitory computer-readable storage medium(s), such as RAM, ROM, EEPROM, EPROM, flash memory devices, magnetic disks, etc., and/or combinations thereof.

The memory device(s) 130B can include one or more computer-readable media and can store information accessible by the one or more processor(s) 130A, including instructions 130C that can be executed by the one or more processor(s) 130A. For instance, the memory device(s) 130B can store instructions 130C for running one or more software applications, displaying a user interface, receiving user input, processing user input, etc. In some implementations, the instructions 130C can be executed by the one or more processor(s) 130A to cause the one or more processor(s) 130A to perform operations, as described herein (e.g., one or more portions of method 200). More specifically, for example, the instructions 130C may be executed to transmit and/or receive occupancy status information. The instructions 130C can be software written in any suitable programming language or can be implemented in hardware. Additionally, and/or alternatively, the instructions 130C can be executed in logically and/or virtually separate threads on processor(s) 130A.

The one or more memory device(s) 130B can also store data 130D that can be retrieved, manipulated, created, or stored by the one or more processor(s) 130A. The data 130D can include, for instance, data indicative of target make-up air flow rates for a given number of room occupants. The data 130D can be stored in one or more database(s). The one or more database(s) can be connected to controller 64 and/or controller 122 by a high bandwidth LAN or WAN, or can also be connected to controller through network(s) 112. The one or more database(s) can be split up so that they are located in multiple locales. In some implementations, the data 130D can be received from another device.

The computing device(s) 130 can also include a communication module or interface 130E used to communicate with one or more other component(s) of control system system (e.g., controllers 64, 120, or 122) over the network(s) 112. The communication interface 130E can include any suitable components for interfacing with one or more network(s), including for example, transmitters, receivers, ports, controllers, antennas, or other suitable components.

The network(s) 112 can be any type of communications network, such as a local area network (e.g. intranet), wide area network (e.g. Internet), cellular network, or some combination thereof and can include any number of wired and/or wireless links. The network(s) 112 can also include a direct connection between one or more component(s) of control system 100. In general, communication over the network(s) 112 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The technology discussed herein makes reference to servers, databases, software applications, and other computer-based systems, as well as actions taken and information sent to and from such systems. It should be appreciated that the inherent flexibility of computer-based systems allows for a great variety of possible configurations, combinations, and divisions of tasks and functionality between and among components. For instance, computer processes discussed herein can be implemented using a single computing device or multiple computing devices (e.g., servers) working in combination. Databases and applications can be implemented on a single system or distributed across multiple systems. Distributed components can operate sequentially or in parallel. Furthermore, computing tasks discussed herein as being performed at the computing system (e.g., a server system) can instead be performed at a user computing device. Likewise, computing tasks discussed herein as being performed at the user computing device can instead be performed at the computing system.

Now that the construction of air conditioner unit 10 and the configuration of control system 100 according to exemplary embodiments has been presented, an exemplary method 200 of controlling an auxiliary fan of a packaged terminal air conditioner unit will be described. Although the discussion below refers to the exemplary method 200 of operating air conditioner unit 10 using control system 100, one skilled in the art will appreciate that the exemplary method 200 is applicable to the operation of a variety of other air conditioning appliances using any suitable switch assembly or control system. In exemplary embodiments, the various method steps as disclosed herein may be performed by controller 64, 120, and/or 122, although a dedicated controller may be used according to alternative embodiments.

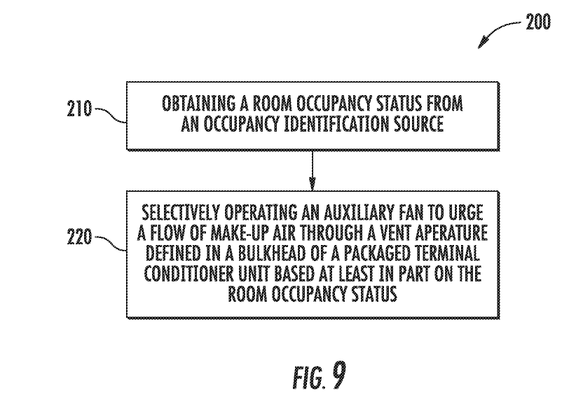

Referring now to FIG. 9, method 200 includes, at step 210, obtaining a room occupancy status from an occupancy identification source. For example, the packaged terminal air conditioner unit may be unit 10 as described above. More specifically, a bulkhead may generally separate the indoor and outdoor portions of the unit and may define a vent aperture through which make-up air may be supplied. Unit 10 may be in operative communication with an occupancy reader, such as a key card reader, directly, through a thermostat, or through one or more wired or wireless networks. However, it should be appreciated that unit 10 is used herein for explanatory purposes only and that aspects of method 200 may be applied to any suitable air conditioner unit.

Method 200 further includes, at step 220, selectively operating an auxiliary fan to urge a flow of make-up air through a vent aperture defined in a bulkhead of a packaged terminal conditioner unit based at least in part on the room occupancy status. For example, the room occupancy status may include the number of room occupants and the flow rate of make-up air may be adjusted to improve guest comfort, minimized energy usage, and eliminate unnecessary noise from an auxiliary fan operating at higher than necessary speeds.

FIG. 9 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 200 are explained using unit 10 as an example, it should be appreciated that this method may be applied to operate suitable air conditioner unit.

The construction of packaged terminal air conditioner unit 10, control system 100, and methods 200 described above provide a means for ensuring that auxiliary fan 92 and make-up air module 90 are selectively operated to ensure that the flow rate of make-up air is appropriate for the number of guests in room 102. In this manner, make-up air module 90 provides the appropriate amount of air to meet government regulations and building codes, keeps the noise created by make-up air module 90 to a minimum, and maintains guest comfort and satisfaction at a maximum. In addition, by automatically adjusting the operation of make-up air module 90 to provide the required amount of make-up air, a facility operator will not need to change the setting in each unit 10 when each guest or guests check into their room.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A control system for controlling an auxiliary fan of a packaged terminal air conditioner unit, the auxiliary fan being positioned adjacent a vent aperture defined in a bulkhead of the packaged terminal conditioner unit, the control system comprising:
an occupancy identification source including data indicative of a room occupancy status;
an occupancy reader configured for reading the occupancy identification source to determine the room occupancy status; and
a controller operably coupled with the occupancy reader and being configured for selectively operating the auxiliary fan based at least in part on the room occupancy status determined by the occupancy reader.

2. The control system of claim 1, wherein the room occupancy status comprises a number of room occupants.

3. The control system of claim 2, wherein selectively operating the auxiliary fan comprises adjusting a volumetric flow rate of a flow of make-up air based at least in part on the number of room occupants.

4. The control system of claim 3, wherein the volumetric flow rate is about twenty cubic feet per minute when there is one room occupant and the volumetric flow rate is about thirty-five cubic feet per minute when there are two or more room occupants.

5. The control system of claim 1, wherein the occupancy reader is a keycard slot and the occupancy identification source is a keycard that is received within the keycard slot.

6. The control system of claim 1, wherein the occupancy identification source is an RFID chip.

7. The control system of claim 1, wherein the occupancy identification source is a cell phone in operative communication with the occupancy reader.

8. The control system of claim 1, wherein the controller is in operative communication with the occupancy reader through a thermostat.

9. The control system of claim 1, wherein the controller comprises a wireless communication module in wireless communication with the occupancy reader.

10. The control system of claim 1, wherein the auxiliary fan is part of a make-up air module positioned proximate the vent aperture and being configured for urging a flow of make-up air from an outdoor portion through the vent aperture to an indoor portion based at least in part on the room occupancy status.

11. A packaged terminal air conditioner unit, comprising:
a bulkhead defining an indoor portion and an outdoor portion;
a vent aperture defined in the bulkhead;
an auxiliary fan positioned proximate the vent aperture and being configured for urging a flow of make-up air from the outdoor portion through the vent aperture to the indoor portion; and
a controller configured for:
obtaining a room occupancy status from an occupancy identification source; and
selectively operating the auxiliary fan based at least in part on the room occupancy status to urge the flow of make-up air through the vent aperture.

12. The packaged terminal air conditioner unit of claim 11, wherein the room occupancy status comprises a number of room occupants.

13. The packaged terminal air conditioner unit of claim 12, wherein selectively operating the auxiliary fan comprises adjusting a volumetric flow rate of the flow of make-up air based at least in part on the number of room occupants.

14. The packaged terminal air conditioner unit of claim 13, wherein the volumetric flow rate is about twenty cubic feet per minute when there is one room occupant and the volumetric flow rate is about thirty-five cubic feet per minute when there are two or more room occupants.

15. The packaged terminal air conditioner unit of claim 11, wherein the occupancy identification source is a keycard that is received within a keycard slot.

16. The packaged terminal air conditioner unit of claim 11, wherein the occupancy identification source is an RFID chip or a cell phone in operative communication with an occupancy reader.

17. A method for controlling an auxiliary fan of a packaged terminal air conditioner unit, the auxiliary fan being positioned adjacent a vent aperture defined in a bulkhead of the packaged terminal conditioner unit, the method comprising:
obtaining a room occupancy status from an occupancy identification source; and
selectively operating the auxiliary fan to urge a flow of make-up air through the vent aperture based at least in part on the room occupancy status.

18. The method of claim 17, wherein obtaining the room occupancy status comprises:
using an occupancy reader to read the occupancy identification source; and
communicating the room occupancy status to a controller of the packaged terminal air conditioner unit.

19. The method of claim 18, wherein the occupancy reader is a keycard slot and the occupancy identification source is a keycard inserted into the keycard slot.

20. The method of claim 17, wherein the room occupancy status comprises a number of room occupants and selectively operating the auxiliary fan comprises adjusting a volumetric flow rate of a flow of make-up air based at least in part on the number of room occupants.
